(19) United States
(12) Patent Application Publication
(10) Pub. No.: US 2007/0033808 A1
(43) Pub. Date: Feb. 15, 2007

(54) PRECISION ADJUSTMENT APPARATUS

(76) Inventors: Alfred Natrasevschi, Fort Collins, CO (US); Jacqueline C. Natrasevschi, Fort Collins, CO (US)

Correspondence Address: Alfred Natrasevschi;Jacqueline C. Natrasevschi, 3608 Jaguar Pl, Fort Collins, CO, 80525, US

(21) Appl. No.: 11/161,716

(22) Filed: Aug. 13, 2005

(51) Int. Cl. B25F 3/00

(52) U.S. Cl. 30/133

(57) ABSTRACT

A precision adjustment apparatus for changing longitudinal and circumferential relative position of telescoping parts. Protrusions and/or indentations on the outside of the inner cylinder or tube are matched to protrusions and/or indentations on the inside of an outer tube. The protrusions are positioned in a linear array on one part and in a circular array on the other. The dimensions and spacing of the protrusions allow interference between them to create a lock for any position while allowing repositioning. A combination of linear and circular arrays can be placed on each tube for enhancing functionality such as stability or adjustability. A haircutting apparatus incorporating the precision adjustment apparatus sets the hair length and the angle of styling and for providing the user with a feedback click-sound and click-feel of each executed adjustment.

### RELATED APPLICATIONS

The present application is related to U.S. Pat. No. 4,602,542, issued Jun. 29, 1986, for AUTOMATIC HAIR CUTTING APPARATUS, by Natrasevschi Alfred, included by reference herein.

### Field of the Invention

The present invention relates to adjustment systems and more particularly, to an adjustment system that is resistant to accidental setting change and is used for a haircutting apparatus.

### BACKGROUND OF THE INVENTION

There is a need for an inexpensive, reliable adjustment system that requires little space.

U.S. Pat. No. 4,602,542, issued to Natrasevschi, discloses a telescoping system for changing the length of a haircut, a threaded shaft and a threaded hole are attached to the respective telescoping parts. A motor turns the shaft that interacts with the threaded hole to adjust the relative position of the telescoping parts.

U.S. Pat. No. 5,503,357, issued to johnson, discloses an adjustment mechanism for telescoping tripod legs comprising a lock mechanism with levers and clamps. The disadvantages are the extra parts besides the telescoping parts as well as extra space and weight.

U.S. Pat. No. 4,020,297, issued to Brodie, discloses a headset with sound conducting tube comprising telescoping sections that adjust in length and rotation and maintain position by friction of cylindrical surfaces. The disadvantage is that friction between cylindrical surfaces is an unreliable means for holding an adjustment against undesired or unanticipated change.

U.S. Pat. No. 6,199,581, issued to Gil, discloses a fill valve with telescoping adjustable standpipe comprising a locking clip that engages a number of grooves for discrete adjustments. The disadvantages consist in allowing only axial adjustment and having extra parts, some loose that can be lost, thus inconveniencing the user.

Presently used adjustment systems can provide significant functionality but often comprise multiple parts. The multiple parts cause high cost, lower reliability, and require more space and weight, all of which are not appropriate for many devices such as hand-held appliances that should be light, small and inexpensive.

Some presently used haircutter systems, such as the RoboCut™ system require only two parts and are low cost, but lack means of positively latching the longitudinal and/or circumferential position.

In order to resolve the user's need for an inexpensive but reliable adjustment system the present applicants have experimented with various adjustment systems to equal or exceed the functionality of more complex, multi-component designs while maintaining the simplicity and low cost of a two component friction design.

It is therefore an object of the invention to create a multitude of sharply defined and stable adjustment positions.

It is another object of the invention to provide means for both linear and radial adjustable positions.

It is another object of the invention to use the minimum possible parts count, as few as, but not limited to two.

It is another object of the invention to reduce or eliminate inadvertent changes of the adjusted position.

It is another object of the invention to provide both acoustic and tactile feedback to the user of the accomplished adjustment.

It is another object of the invention to provide acoustic and tactile feedback to the user of undesired change in adjustment.

It is another object of the invention to reduce or eliminate wobbling or loose connection or wiggles between the adjusted parts.

It is another object of the invention to reduce or eliminate vibration and noise.

It is another object of the invention to reduce weight.

It is another object of the invention to reduce space requirement.

It is another object of the invention to provide compact implementation.

It is another object of the invention to reduce cost.

It is another object of the invention to increase reliability via low parts count.

It is another object of the invention to increase reliability via low movable-part count.

It is another object of the invention to provide a haircutter with a reliable and precise adjustment capability.

It is another object of the invention to provide a vacuum haircutter with a reliable and precise adjustment capability.

### SUMMARY OF THE INVENTION

In accordance with the present invention, there is provided a precision adjustment apparatus which can comprise as few as, but not limited to two parts, an inner-part and an outer-part. The two parts can be either two telescoping tubes or a tube and a telescoping inner-cylinder.

The inner-part has a plurality of raised features or indented features on its outside surface, said features being positioned in an axial linear array or a circumferential array.

The outer-part is slidably and telescopingly connected to the inner-part, has a plurality of raised features or indented features on it's inside surface. These raised features are positioned in an axial-linear array or a circumferential array so that the choice of axial or circumferential is the opposite of the choice on the inner-part. The raised features have dimensions, shape and spacing that cause interference between the inner-part and the outer-part. Such interference creates a locking mechanism for any given linear or radial relative position, said position being signaled by a lock-sound and lock-feel. The position is changeable only if force exceeds a threshold that is high enough for confidence in the stability of the relative position.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a drawing of the precision adjustment apparatus of the invention, comprising telescoping tubes;

FIG. 2 is a drawing of the haircutter with precision adjustment apparatus for length and angle adjustment with flat outer part;

FIG. 3 is the main view from FIG. 2, magnified;

FIG. 4 is a drawing of the haircutter with precision adjustment apparatus for length and angle adjustment with angled outer part.

FIG. 5 is the main view from FIG. 4, magnified;

For purposes of clarity and brevity, like elements and parts will bear the same designations and numbering throughout the FIGURES.

### DESCRIPTION OF THE PREFERRED EMBODIMENT

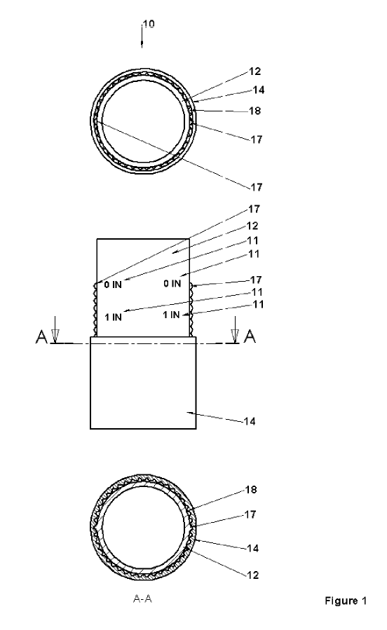

FIG. 1 is an assembly view of the precision adjustment apparatus 10, in accordance with this invention. An inner-part 12 in the form of a tube and an outer-part 14 in the form of a tube are telescopingly assembled. The inner-part 12 can be a solid cylinder or a hollow tube, of round, rectangular, polygonal, irregular or other suitable cross section. The inner-part 12 can be made of plastic, metal or any other suitable material. The outer-part 14 may be a tube of round, rectangular, polygonal, irregular or any other suitable cross section to accommodate the shape of the inner-part 12. The outer-part 14 can be made of plastic, metal or any other suitable material, transparent or opaque. In the preferred embodiment the inner-part 12 is a tube made of less transparent material and the outer-part 14 is a tube made of more transparent material.

An inner-array 17 is rectilinear, composed of two rows rigidly attached to the outer surface 13 of the inner-part 12. The outer-array 18 is circular and rigidly attached to the inner surface 15 of the outer-part 14. The inner-array 17 and the outer-array 18 are axially-lockingly and circumferentially-lockingly connected so as to provide interference between the outer-part 14 and the inner-part 12. The inner-array 17 and outer-array 18 appear as irregularities in the outer surface of the inner-part 12 and the inner surface of the outer-part 14 respectively. The irregularities may be protrusions or indentations. The irregularities may have a revolved surface shape such as spherical, semispherical, conical, or other suitable revolved shape or the irregularities may have a multifaceted surface shape such as prismatic, cubical or any other suitable multifaceted shape. The distribution of the inner-array 17 and the outer-array 18 on the surfaces of the inner-part 12 and the outer-part 14 can be axial, circumferential, helical, or any suitable distribution. The inner-array 17 and outer-array 18 may bear markings that describe the relative position of the inner-part 12 versus the outer-part 14 in terms of length and angle or in terms of axial and rotational position. Thus an axial array may be spaced at regular intervals of length and marked as a ruler. In FIG. 1, the axial inner-array 17 can have protrusions spaced at 0.25 inch and can bear the markings 11 accordingly at inch intervals: 0 in, 1 in, 2 in or any suitable markings. A circumferential array may be spaced at regular intervals of angle and marked, not shown, as a protractor. In the preferred embodiment, the inner-part 12 has two diametrically opposed axial inner-arrays of semispherical protrusions while the outer-part 14 has a radial outer-array 18 of semispherical protrusions.

The operation of the precision adjustment apparatus 10 requires applying enough external force between the inner-part 12 and outer-part 14 so as to cause an axial and/or circumferential relative position change. The application of the force is discontinued when the desired relative position between the inner-part 12 and outer-part 14 has been achieved. The position change occurs when the applied force exceeds the resistance force that is created by the interference between the inner-array 17 and outer-array 18. The position change is associated with a tactile feedback (e.g., a jump) for every irregularity passed over and an acoustic feedback (e.g., an audible click) for every irregularity passed over. The targeted relative position can be recognized via the ruler markings 11 and/or protractor markings (not shown).

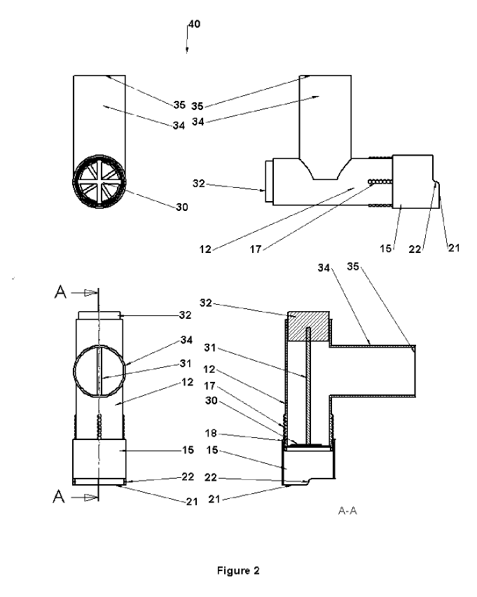

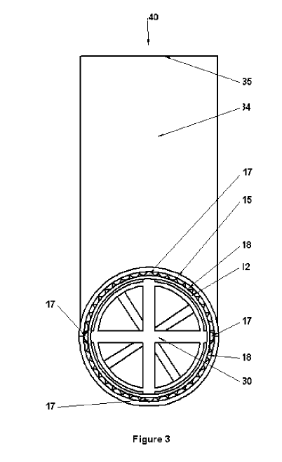

FIG. 2 and FIG. 3 show assembly views of an alternate embodiment of the precision adjustment apparatus 10 integrated in a vacuum haircutter 40 for the purpose of adjusting and determining the length to which hair will be cut and/or for changing the circumferential position of styling ends such as styling ends for straight and angled cutting. In this embodiment the inner-array 17 is rectilinear, composed of four rows rigidly attached to the outer surface 13 of the inner-part 12. In this embodiment, the styling end is the straight-outer-part 15. The straight-outer-part 15, the inner-part 12 and the vacuum connection 34 form an air-flow chamber. A blade or scissors assembly 30 is fixedly attached to the front end of the inner-part 12 and rotatingly attached through the shaft 31 to an electric drive 32. The electric drive 32 is fixedly attached to the back end of the inner-part 12. The vacuum connection 34 is flexibly or rigidly attached to a vacuum source 35, not shown. In this embodiment the straight-outer-part 15 has an edge 21 that defines a straight plane for touching the scalp, not shown. Also the straight-outer-part 15 has a side opening 22 for air-intake at the interface with the scalp, not shown. In this implementation, the position on the inner-array 17 determines the hair length while the position on the outer-array 18 determines the circumferential position of the air and thus hair intake.

In operation the electric drive 32 is electrically powered from the mains or a battery and mechanically powers the cutting action of the scissors assembly 30. The vacuum source 35 can be a vacuum cleaner or other suitable appliance to provide airflow intake from the straight-outer-part 15 through the inner-part 12 and to the vacuum connection 34. The vacuum haircutter 40 touches the user's scalp with the end 21 of the straight-outer-part 15 and cuts the hair at a length equal to the distance between the end 21 of the straight-outer-part 15 and the blade. The length of the hair can be adjusted by putting one hand on the inner-part 12 and the other hand on the straight-outer-part 15, applying axial force until they move relative to each other, hearing and feeling the clicking feedback of the inner-array 17 interfering with the outer-array 18 and continuing until the desired length is reached. The circumferential position of the air-and-hair-intake 22 can be adjusted by putting one hand on the inner-part 12 and the other hand on the straight-outer-part 15, applying rotational force until they move relative to each other, hearing and feeling the clicking feedback of the inner-array 17 interfering with the outer-array 18 and continuing until the desired circumferential position is reached. The circumferential positioning is useful for styling hair for example around protrusions such as ears where the stylist may prefer to orient the air-intake 22 away from the ear.

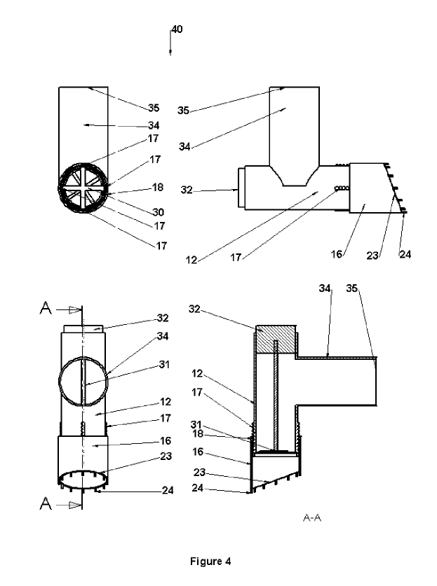

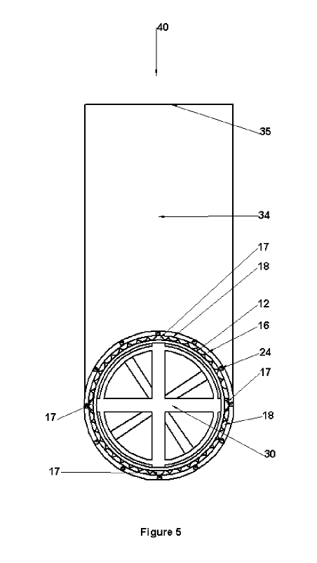

FIG. 4 and FIG. 5 show assembly views of an alternate embodiment of the precision adjustment apparatus 10 integrated in a vacuum haircutter 40 for the purpose of adjusting and determining the length to which hair will be cut and/or for changing the circumferential position of styling ends such as styling ends for straight and angled cutting. In this embodiment the inner-array 17 is rectilinear, composed of four rows rigidly attached to the outer surface 13 of the inner-part 12. In this embodiment, the styling end is the angled-outer-part 16. The angled-outer-part 16 has an angled-end 23 for styling hair in a tapered fashion. The angled-end 23 has protrusions 24 in order to allow air and hair intake. The angled-end 23 is slanted, determines the angle at which the blade is positioned versus the scalp and in turn it determines the angle of tapering of the hair. In this implementation, the position on the inner-array 17 determines the hair length while the position on the outer-array 18 determines the direction of the tapering of the hair.

In operation, the electric drive 32 is electrically powered from the mains or a battery and mechanically powers the cutting action of the scissors assembly 30. The vacuum source 35 can be a vacuum cleaner or other suitable appliance. It conducts airflow from the angled-outer-part 16 through the inner-part 12 and to the vacuum connection 34. The vacuum haircutter 40 touches the scalp with the end 23 of the angled-outer-part 16 and cuts the hair at a length equal with the distance between the said end and the blade. The length of the hair can be adjusted by putting one hand on the inner-part 12 and the other hand on the angled-outer-part 16, applying axial force until they move relative to each other, hearing and feeling the clicking feedback of the inner-array 17 interfering with the outer-array 18 and continuing until the desired length is reached. The circumferential position of the angled-outer-part 16 can be adjusted by putting one hand on the inner-part 12 and the other hand on the angled-outer-part 16, applying rotational force until they move relative to each other, feeling and listening to the clicking feedback of the inner-array 17 interfering with the outer-array 18 and continuing until the desired circumferential position is reached. The circumferential positioning is useful for styling hair because it determines the direction in which the hair will be tapered.

Thus, in summary, it can be seen that what is provided in this invention is a precision adjustment apparatus 10 that is functional for any application as well as particularly for haircutting settings of length and angle.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A precision adjustment apparatus for changing longitudinal and circumferential relative position of telescoping parts comprising:
means for providing the telescoping inner part of the adjustment apparatus;
means for providing the telescoping outer part of the adjustment apparatus, slidably connected to said means for providing the telescoping inner part of the adjustment apparatus;
means for providing interference with the said means for providing the telescoping outer part, rigidly connected to said means for providing the telescoping inner part of the adjustment apparatus; and
means for providing interference with said means for providing the telescoping inner part, axially-lockingly and circumferentially-lockingly connected to said means for providing interference with the outer part, and rigidly connected to said means for providing the telescoping outer part of the adjustment apparatus.

2. The precision adjustment apparatus in accordance with claim 1, wherein said means for providing the telescoping inner part of the adjustment apparatus comprises a cylindrical inner-part.

3. The precision adjustment apparatus in accordance with claim 1, wherein said means for providing the telescoping inner part of the adjustment apparatus comprises tubular inner-part.

4. The precision adjustment apparatus in accordance with claim 1, wherein said means for providing the telescoping inner part of the adjustment apparatus comprises an inner-part of circular cross-section.

5. The precision adjustment apparatus in accordance with claim 1, wherein said means for providing the telescoping inner part of the adjustment apparatus comprises an inner-part of rectangular cross-section.

6. The precision adjustment apparatus in accordance with claim 1, wherein said means for providing the telescoping outer part of the adjustment apparatus comprises an outer-part that is tubular and functionally matches said inner-part.

7. The precision adjustment apparatus in accordance with claim 1, wherein said means for providing interference with the outer part comprises a suitable number of axial arrays of shapes as an inner-array.

8. The precision adjustment apparatus in accordance with claim 1, wherein said means for providing interference with the outer part comprises a suitable number of circumferential arrays of shapes as an inner-array.

9. The precision adjustment apparatus in accordance with claim 1, wherein said means for providing interference with the outer part comprises protruding shapes as an inner-array.

10. The precision adjustment apparatus in accordance with claim 1, wherein said means for providing interference with the outer part comprises indented shapes as an inner-array.

11. The precision adjustment apparatus in accordance with claim 1, wherein said means for providing interference with the outer part comprises revolved shapes as an inner-array.

12. The precision adjustment apparatus in accordance with claim 1, wherein said means for providing interference with the outer part comprises multifaceted shapes as an inner-array.

13. The precision adjustment apparatus in accordance with claim 1, wherein said means for providing interference with the inner part comprises a suitable number of outer-arrays that functionally match the inner arrays.

14. A precision adjustment apparatus for changing longitudinal and circumferential relative position of telescoping parts comprising:
an inner-part, for telescoping an inner portion of the adjustment apparatus;
an outer-part, for telescoping an outer portion of the adjustment apparatus, slidably connected to said inner-part;
an inner-array, for providing axial and circumferential interference with said outer-part, rigidly connected to said inner-part; and
an outer-array, for providing axial and circumferential interference with said inner-part, axially and circumferentially interfering with said inner-array, and rigidly connected to said outer-part.

15. The precision adjustment apparatus in accordance with claim 14, wherein said inner-array interferes with the outer-array such as to allow axial adjustment in axial increments.

16. The precision adjustment apparatus in accordance with claim 14, wherein said inner-array interferes with the outer-array such as to allow circumferential adjustment in circumferential increments.

17. The precision adjustment apparatus in accordance with claim 14, wherein said inner-array interferes with the outer-array such as to allow any combination of axial adjustments in axial increments and circumferential adjustment in circumferential increments.

18. A haircutter for cutting hair at a variety of lengths, angles and angle orientations comprising:
a precision adjustment apparatus as recited in claim 14 for conducting air flow and hair and for adjustment of haircutting length, haircutting angle and haircutting angle orientation;
a blade operatively connected to the front end of said inner-part of said precision adjustment apparatus for cutting hair at a predetermined length and angle;
an electric drive moveably attached to said blade and fixedly attached to the back end of said inner-part of said precision adjustment apparatus for driving the scissors assembly; and
a vacuum connection fixedly attached at one end of said inner-part of said precision adjustment apparatus and attached at the other end to a vacuum source for providing the air flow and for conducting the hair cuttings to disposal.
